(19) United States
(12) Patent Application Publication
(10) Pub. No.: US 2006/0011660 A1
(43) Pub. Date: Jan. 19, 2006

(54) Portable dispensing apparatus

(76) Inventor: Tamara M. Sandlin, Carmel, IN (US)

Correspondence Address: FRASER MARTIN BUCHANAN MILLER LLC, 132C WEST SECOND STREET, PERRYSBURG, OH, 43551-1401, US

(21) Appl. No.: 10/890,422

(22) Filed: Jul. 13, 2004

(51) Int. Cl. G01F 11/36

(52) U.S. Cl. 222/321.9

(57) ABSTRACT

A portable dispensing apparatus is disclosed which stores and dispenses a variety of fluid materials and solid materials, the apparatus includes a unitary main body having a first storage chamber for storing a fluid material and a second storage chamber formed therein for storing a solid material.

### FIELD OF THE INVENTION

The invention relates to a portable dispensing apparatus and more particularly a portable dispensing apparatus for storing and dispensing a variety of fluid materials and solid materials.

### BACKGROUND OF THE INVENTION

In every day life, there exists a need for storing and dispensing a variety of materials which may be fluid or solid. Materials such as toiletries or personal hygiene materials are one example of such materials. These may include water, perfume, mouthwash, suntan lotion or oil, cleansers, cleaners, cotton pads, deodorant, lipstick, soap, breath mints, pads impregnated with other materials and the like. Thus, in order to store and dispense these materials, a variety of containers are needed. Due to the large number of containers required, a large quantity of waste is likewise generated. For some materials which are related by function or use, it may be desirable to conveniently access those materials at the same time, thus minimizing the time required for use and maximizing an efficient use of time.

An example of related use or function is the injection of fluids into the human body using hypodermic needles. This requires that the region of the skin to be punctured be prepared for the injection. Typically, an individually wrapped disposable swab is used which is usually pre-saturated with a disinfectant material or sterilizing liquid such as isopropyl alcohol. To prevent cross contamination between patients, the swab used for the preparation process must be discarded after a single use. In an environment where numerous injections are given such as a hospital, for example, a large number of swabs and a large quantity of the disinfectant material or sterilizing liquid must always be available.

The swabs typically are individually wrapped in packaging which is as voluminous as the swab itself, thus creating a high degree of packaging waste. Further, the person administering the injection must carry a large number of swabs or arrange to have the swabs stored in or near each point of use. A further disadvantage is the swabs have a tendency to dry out fairly quickly due to the volatility of the sterilizing liquid, at times requiring the use of more than one swab on a single patient. Thus, even a small hospital or medical facility will use hundreds of swabs on a typical day, generating a large amount of waste and expense. The present invention addresses these problems by providing dry swabs and a user determined amount of a topical treatment agent that is applied at the point of use, embodied as a unitary portable unit.

It would be desirable to produce a portable dispensing apparatus wherein waste is minimized and user efficiency is maximized.

### SUMMARY OF THE INVENTION

Consistent and consonant with the present invention, a portable dispensing apparatus wherein waste is minimized and user efficiency is maximized, has surprisingly been discovered.

In one embodiment, the portable dispensing apparatus comprises a unitary hollow main body having a first end and a second end, the main body including a first storage chamber and a second storage chamber formed therein, the first storage chamber adapted to store a fluid therein, the second storage chamber adapted to store a solid material therein and having an open end; a dispensing nozzle in fluid communication with the first storage chamber to dispense the fluid material from the first storage chamber; and an urging mechanism disposed in the second storage chamber to urge the solid material towards the open end of the second storage chamber.

In another embodiment, the portable dispensing apparatus comprises a unitary hollow main body having a first end and a second end, the main body including a first storage chamber and a second storage chamber formed therein, the second storage chamber adapted to store a solid material therein and having an open end; a storage container disposed in the first storage chamber, the storage container adapted to store a fluid material therein; a dispensing nozzle connected to the storage container and in fluid communication with the fluid material disposed therein to dispense the fluid material from the storage container; and an urging mechanism disposed in the second storage chamber to urge the solid material towards the open end of the second storage chamber.

The invention also provides methods of preparing an external surface region of a skin of a patient.

One method according to the invention comprises the steps of providing a portable dispensing apparatus comprising a unitary hollow main body with a first end and a second end, the main body including a first storage chamber and a second storage chamber formed therein, the first storage chamber adapted to store a topical treatment agent therein, the second storage chamber adapted to store a plurality of pads therein and having an open end; a dispensing nozzle in fluid communication with the first storage chamber to dispense the topical treatment agent from the first storage chamber; and an urging mechanism disposed in the second storage chamber to urge the pads towards the open end of the second storage chamber for selective removal through the open end of the second storage chamber as desired; operating the dispensing nozzle to draw the topical treatment agent from the first storage chamber and dispense the topical treatment agent onto the external surface region of the skin of the patient; removing one of the pads from the second storage chamber; and dispersing the topical treatment agent with the one of the pads on the external surface region of the skin of the patient.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is an elevational view partially in section of a portable dispensing apparatus according to an embodiment of the invention;

FIG. 2 is an exploded elevational view of the apparatus illustrated in FIG. 1;

FIG. 3 is a front perspective view of the apparatus illustrated in FIGS. 1 and 2 showing a first cap in an open position;

FIG. 4 is a rear perspective view of the apparatus illustrated in FIGS. 1 and 2 showing a second cap in an open position; and

FIG. 5 is an elevational view of a portable dispensing apparatus according to another embodiment of the invention.

### DESCRIPTION OF THE PREFERRED EMBODIMENT

Commonly owned U.S. Pat. No. 6,394,987 B1 is hereby incorporated herein by reference.

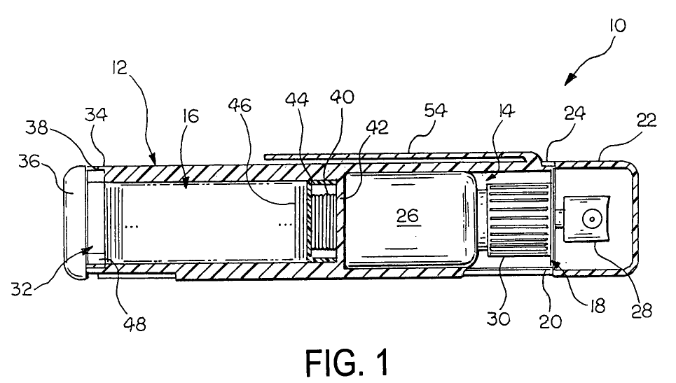

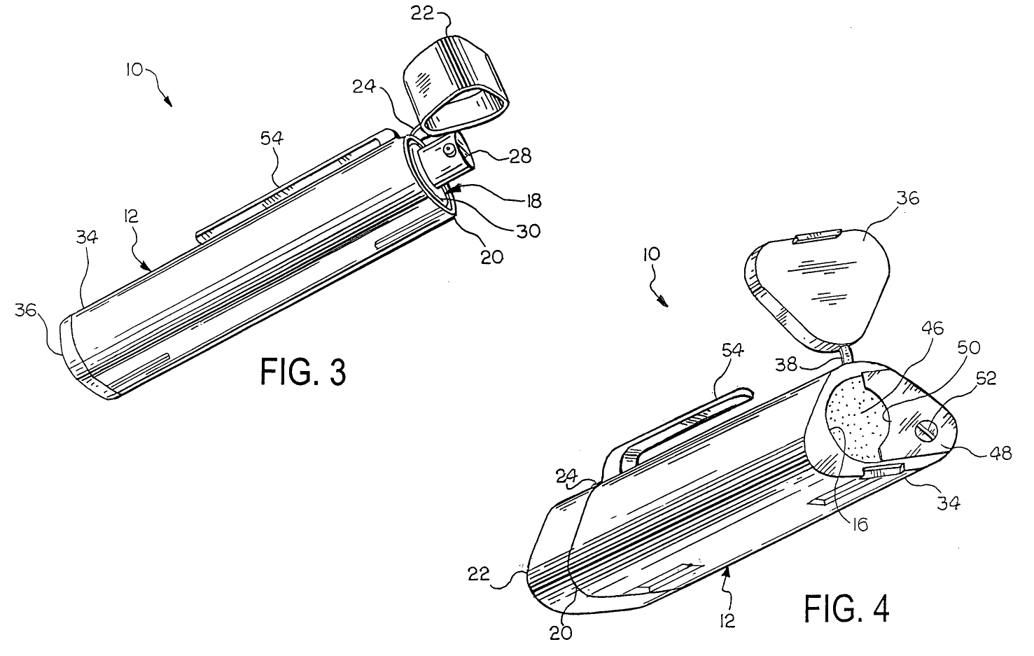

Referring now to FIG. 1, a portable dispensing apparatus 10 according to an embodiment of the invention is shown. The portable dispensing apparatus 10 includes a hollow main body 12, formed of any conventional durable material such as a plastic material, for example. The main body 12 has a generally triangular cross-sectional shape as shown in FIGS. 3 and 4 and includes a first storage chamber 14 and a second storage chamber 16 formed therein. The triangular shape of the main body 12 facilitates a manual gripping of the main body 12 by a user and provides stability when the portable dispensing apparatus 10 is place on a flat surface.

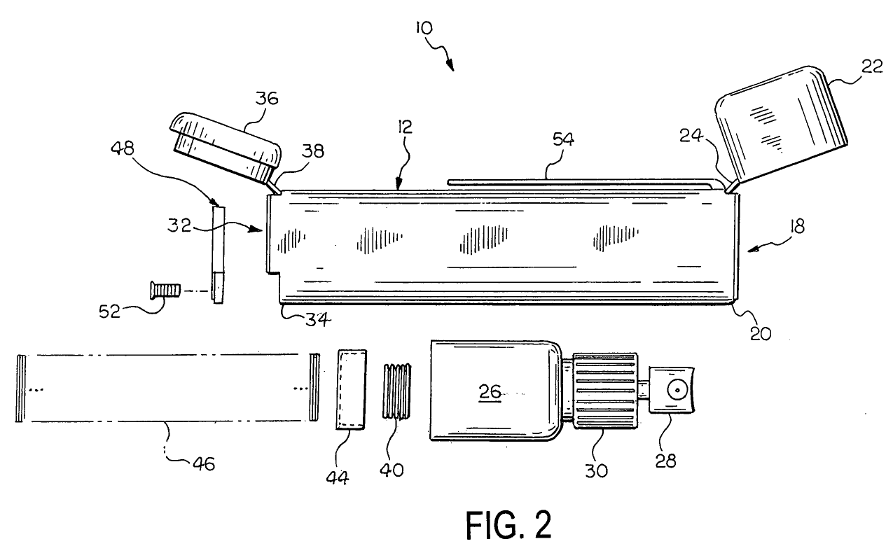

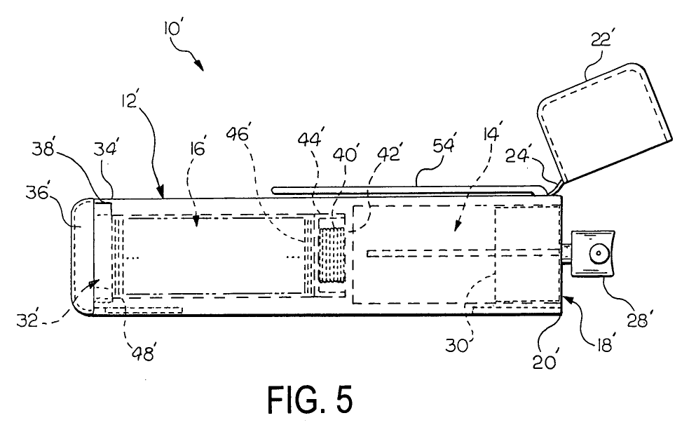

The first storage chamber 14 has an opening or open end 18 formed adjacent a first end 20 of the main body 12. A lid or cap 22 is provided to cover the opening 18. In the embodiment shown, the cap 22 is hingedly attached to the main body 12 by a living hinge 24, as clearly shown in FIGS. 2 and 3. It is understood that the cap 22 may be connected to the main body 12 by any conventional means or releasably attached by any conventional means such as threads or press fit, for example. The first storage chamber 14 is adapted to receive a storage container or spray bottle 26 therein. A spray pump or dispensing nozzle 28 is provided with the spray bottle 26 and extends through the opening 18 to be housed in the cap 22. The spray pump 28 can also be sealingly disposed in the opening 18 to be in direct fluid communication with the first storage chamber 14, as shown in FIG. 5. For clarity, repeated structure in FIG. 5 is shown with the same reference numeral and a prime symbol. The spray pump 28′ can be connected to the main body 12′ by any conventional means such as a threaded connection or press fitting, for example. The remaining discussion of the structure disclosed in FIGS. 1-4 and the use and operation thereof also applies to the structure disclosed in FIG. 5.

A threaded collar 30 is provided on the spray pump 28 and is threadingly engaged with the spray bottle 26 to facilitate removal of the spray pump 28 from the spray bottle 26 for refilling of the contents thereof. In the embodiment shown, the spray bottle 26 contains a topical treatment agent which may include an antiseptic, disinfectant, or sterilizer. The topical treatment agent may be isopropyl alcohol, for example. It is understood that other fluid materials could be used such as water, perfume, mouthwash, suntan lotion or oil, cleansers, and cleaners, for example, without departing from the scope and spirit of the invention.

The second storage chamber 16 has an opening or open end 32 formed adjacent a second end 34 of the main body 12. A lid or cap 36 is provided to cover the opening 32. In the embodiment shown, the cap 36 is hingedly attached to the main body 12 by a living hinge 38, as clearly shown in FIGS. 2 and 4. It is understood that the cap 36 may be connected to the main body 12 by any conventional means or releasably attached by any conventional means such as threads or press fit, for example. A spring or urging mechanism 40 is provided at the end of the second storage chamber 16 opposite the opening 32. In the embodiment shown, a coil spring is used. It is understood that other spring or spring mechanism types can be used without departing from the scope and spirit of the invention. It is also understood that other urging mechanisms may be used such as a threaded or helically actuated pressure plate whereby a twisting or turning of the structure causes the pressure plate to advance towards the second end 34 of the main body 12, for example. The threaded or helically actuated pressure plate structures are commonly used in lipstick containers and deodorant containers and are well known in the art.

One end of the spring 40 abuts a wall 42 formed between the first storage chamber 14 and the second storage chamber 16. The wall 42 can be a solid structure as shown or can have at least one aperture formed therein to provide communication between the first storage chamber 14 and the second storage chamber 16. It is understood that a lip providing a seating surface or shoulder for the spring 40 can also be used as desired. The other end of the spring 40 abuts a push block 44 slidingly disposed in the second storage chamber 16. In the embodiment shown, a plurality of sterile pads 46 is stacked in the second storage chamber 16 and abuts the push block 44. It is understood that other solid materials such as cleansers, cleaners, deodorant, lipstick, soap, breath mints, pads impregnated with other materials and the like, for example, can be used without departing from the scope and spirit of the invention. A pad blocker or retainer 48 is disposed at the opening 32 to abut the pads 46 and militate against the pads 46 exiting the second storage chamber 16 and facilitate selective removal thereof. As more clearly shown in FIG. 4, the pad blocker 48 has an arcuate outer edge 50 to facilitate manual removal of the pads 46 from the second storage chamber 16 by the user. A threaded fastener 52 releasably holds the pad blocker 48 in the desired position. Removal of the threaded fastener 52, and thus the pad blocker 48 facilitates a refilling of the pads 46 in the second storage chamber 16. It is understood that other fastening means can be used as desired to releasably attach the pad blocker 48 to the main body 12. It is also understood that the pad blocker 48 can be formed as part of the main body 12. Where deodorant, lipstick, soap, and like materials stored and dispensed from the portable dispensing apparatus, the pad blocker may not be necessary and can be removed.

A hanger clip 54 is formed on an outer surface of the main body 12. The hanger clip 54 facilitates storage of the portable dispensing apparatus 10 in the pocket of the user.

An exemplary use of the portable dispensing apparatus 10 is by medical care providers as a tool when giving injections to a patient. When preparing to give an injection of medication or other material into the body of the patient, the external surface region of the skin where the injection is to be given must be prepared to militate against the introduction of undesirable contaminants into the body of the patient. The steps presented herein are exemplary in nature, and thus, the order is not necessary or critical. To prepare the external surface region of the skin, the cap 22 is removed to expose the spray pump 28. The medical care provider then manually operates the spray pump 28 to draw the fluid material or topical treatment agent from the spray bottle 26 and spray the topical treatment agent onto the external surface region of the skin. The cap 36 is removed to expose the pads 46. One of the pads 46 is selectively removed from the second storage chamber 16. The pad 46 is then used to disperse the topical treatment agent and remove the excess from the external surface region of the skin. The pad 46 is disposed of to prevent cross-contamination between patients or other external surface regions of the skin. The process can be repeated as desired to ensure that the external surface region of the skin has been satisfactorily prepared. The external surface region of the skin is now ready for the injection. The caps 22, 36 can be replaced and the portable dispensing apparatus 10 is ready for re-use as desired on another patient or to prepare another external surface region of the skin.

When the supply of the topical treatment agent in the spray bottle 26 has been used, the spray bottle 26 can be refilled with the topical treatment agent by removing the collar 30 and spray pump 28. Alternatively, the spray bottle 26 can be replaced with a new spray bottle 26 including the topical treatment agent. In the embodiment illustrated in FIG. 5, the spray pump 28′ is removed and the first storage chamber 14′ is refilled with the topical treatment agent.

As pads 46 are removed from the second storage chamber 16, the spring 40 urges the push block 44 and the pads 46 towards the opening 32. Once the supply of the pads 46 stored in the second storage chamber 16 has been exhausted, the pad blocker 48 can be removed and a new supply of pads 46 added. The pad blocker 48 is then reinstalled and the portable dispensing apparatus 10 is again ready for use. The second storage chamber 16 cooperates with the cap 36 to store the pads 46 in a clean manner.

Since the main body 12 is a unitary structure not having separate components, loss of those separate components is militated against. The spray bottle 26 and the pads 46 can be easily replaced within the first storage chamber 14 and the second storage chamber 16 as desired. Additionally, the unitary structure of the main body 12 is easily and inexpensively formed, thus providing a structure capable of conveniently storing and dispensing both fluids and solids that can be used when traveling and disposable if desired.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A portable dispensing apparatus comprising:
a unitary hollow main body having a first end and a second end, said main body including a first storage chamber and a second storage chamber formed therein, the first storage chamber adapted to store a fluid therein, the second storage chamber adapted to store a solid material therein and having an open end;
a dispensing nozzle in fluid communication with the first storage chamber to dispense the fluid material from the first storage chamber; and
an urging mechanism disposed in the second storage chamber to urge the solid material towards the open end of the second storage chamber.

2. The apparatus according to claim 1, wherein the fluid material is a topical treatment agent.

3. The apparatus according to claim 1, wherein the fluid material is one of water, perfume, mouthwash, suntan lotion, oil, cleansers, and cleaners.

4. The apparatus according to claim 1, wherein the solid material is a plurality of pads.

5. The apparatus according to claim 1, wherein the solid material is one of cleansers, cleaners, deodorant, lipstick, soap, a plurality of breath mints, and a plurality of impregnated pads.

6. The apparatus according to claim 1, further comprising a storage container disposed in the first storage chamber, said storage container adapted to store the fluid material therein, said dispensing nozzle being connected to said storage container and in fluid communication with the fluid material disposed therein.

7. The apparatus according to claim 1, further comprising a first cap releasably attached to said main body adjacent the first end thereof to house said dispensing nozzle.

8. The apparatus according to claim 1, further comprising a second cap releasably attached to said main body adjacent the second end thereof to cover the open end of the second storage chamber.

9. The apparatus according to claim 1, further comprising a retainer disposed on the second end of said main body to abut the solid material and facilitate selective removal thereof from the second storage chamber.

10. The apparatus according to claim 1, wherein the first storage chamber and the second storage chamber are divided by a wall formed in said main body.

11. The apparatus according to claim 1, wherein said urging mechanism includes a push block to urge the solid material.

12. A portable dispensing apparatus comprising:
a unitary hollow main body having a first end and a second end, said main body including a first storage chamber and a second storage chamber formed therein, the second storage chamber adapted to store a solid material therein and having an open end;
a storage container disposed in the first storage chamber, said storage container adapted to store a fluid material therein;
a dispensing nozzle connected to said storage container and in fluid communication with the fluid material disposed therein to dispense the fluid material from said storage container; and
an urging mechanism disposed in the second storage chamber to urge the solid material towards the open end of the second storage chamber.

13. The apparatus according to claim 12, wherein the fluid material is a topical treatment agent.

14. The apparatus according to claim 12, wherein the fluid material is one of water, perfume, mouthwash, suntan lotion, oil, cleansers, and cleaners.

15. The apparatus according to claim 12, wherein the solid material is a plurality of pads.

16. The apparatus according to claim 12, wherein the solid material is one of cleansers, cleaners, deodorant, lipstick, soap, a plurality of breath mints, and a plurality of impregnated pads.

17. The apparatus according to claim 12, further comprising a retainer disposed on the second end of said main body to abut the solid material and facilitate selective removal thereof from the second storage chamber.

18. The apparatus according to claim 12, wherein the first storage chamber and-the second storage chamber are divided by a wall formed in said main body.

19. The apparatus according to claim 12, wherein the urging mechanism is a spring.

20. A method of preparing an external surface region of skin of a patient, the method comprising the steps of:
providing a portable dispensing apparatus comprising:
a unitary hollow main body with a first end and a second end, the main body including a first storage chamber and a second storage chamber formed therein, the first storage chamber adapted to store a topical treatment agent therein, the second storage chamber adapted to store a plurality of pads therein and having an open end;
a dispensing nozzle in fluid communication with the first storage chamber to dispense the topical treatment agent from the first storage chamber; and
an urging mechanism disposed in the second storage chamber to urge the pads towards the open end of the second storage chamber for selective removal through the open end of the second storage chamber as desired;
operating the dispensing nozzle to draw the topical treatment agent from the first storage chamber and dispense the topical treatment agent onto the external surface region of the skin of the patient;
removing one of the pads from the second storage chamber; and
dispersing the topical treatment agent with the one of the pads on the external surface region of the skin of the patient.
